(19) United States
(12) Patent Application Publication
(10) Pub. No.: US 2003/0105736 A1
(43) Pub. Date: Jun. 5, 2003

(54) System and method for analyzing and classification of files

(75) Inventor: Goren Gordon, Rishon Le-Zion (IL)

Correspondence Address: LYON & LYON LLP, 633 WEST FIFTH STREET, SUITE 4700, LOS ANGELES, CA, 90071, US

(73) Assignee: Gordonomics Ltd.

(21) Appl. No.: 10/146,499

(22) Filed: May 14, 2002

(30) Foreign Application Priority Data
Nov. 21, 2001 PCT/IL01/01074
Nov. 20, 2001 (IL) 146597

(51) Int. Cl. G06F 7/00

(52) U.S. Cl. 707/1

(57) ABSTRACT

A system and method for analysis and classification of electronic information is disclosed. The method comprises receiving a file from an input device, calculating the complexity of the file received, classifying the complexities of the file; displaying the file on a user interface; and storing the file and their given classifications. The system comprises an input device for capturing files; a computing device for calculating complexities of the captured files; a computing device for classification of complexities of files interacting with a storage device, a user interface and the input device; wherein the storage device provides the computing device, the user interface and input device with relevant information of the captured, analyzed and classified files; and wherein the user interface device displays files and their classifications to a user.

### CROSS REFERENCE TO RELATED APPLICATIONS

This application claims priority from PCT Application No. PCT/IL01/01074, filed Nov. 21, 2001, and Israeli Patent Application No. 146597, filed Nov. 20, 2001, each of which is hereby incorporated by reference as if fully set forth herein.

### BACKGROUND OF THE INVENTION

The present invention relates to the detection and classification of text files according to the level of its encryption.

Many files are transferred over the Internet and other communication lines on daily basis for leisure, business, military and various other purposes. The present accessibility for receiving files over versatile communication lines to ever-growing amount of users around the world is a great advantage. However, the said accessibility results un-occasionally with files that are addressed to a particular destination to reach other destinations. Consequently, files including private or confidential information can be inspected by unauthorized elements. Inspection by unauthorized elements may cause mere inconvenience when the said files contain personal private information. Business secrets exposed to competitors or dishonest persons can cause grave financial losses. Furthermore, military secrets inspected by unauthorized persons or hostile elements may damage relationships between states and endanger people's lives. The un-occasional phenomenon of erring reception of files and its possible consequences has resulted with the need to encrypt files sent over communication lines.

Encrypted files can appear to be for a person unaware of its encryption as an unencrypted message. Thus, an erred receiver of a file over a communication line can be misled believing the received file as inspected provides all data within the file. However, this advantage can result with a drawback, a person addressed for an encrypted file can not always be aware of receiving an encrypt file. A furthermore disadvantage may result incase of military use, while downloading messages transferred over a communication line between hostile elements one can not be aware of the real data or message conveyed between the said elements.

A further existing need is for selection of files received by end users over the Internet and other communication lines. There are many types of files that an end user can receive such as text files, image files and others. An end user can process and manage each type of file in a different manner. An early knowledge of incoming file type can save processing time and storage place. While one end user may desire to receive only one particular type of files over the Internet and other communication lines the connecting communication lines can provide a variety of undesired files. There is a growing need for enabling an end user to pre-select incoming files according to their type.

There is therefore a need in the art for a method and system for analyzing and classifying file types and for detecting between encrypted and un-encrypt files transferred over communication lines.

### SUMMARY OF THE INVENTION

A system and method for analysis and classification of electronic information is disclosed.

The method comprises receiving a file from an input device, calculating the complexity of the file received, classifying the complexities of the file; displaying the file on a user interface; and storing the file and their given classifications.

The system comprises an input device for capturing files; a computing device for calculating complexities of the captured files; a computing device for classification of complexities of files interacting with a storage device, a user interface and the input device; wherein the storage device provides the computing device, the user interface and input device with relevant information of the captured, analyzed and classified files; and wherein the user interface device displays files and their classifications to a user.

### BRIEF DESCRIPTION OF THE DRAWINGS

FIG. 1 depicts a block diagram illustrating the process executed by the encryption analysis and classification system; and

FIG. 2 illustrates a preferred embodiment of the present invention and particularly a screen shot presenting the unsorted incoming file column list and the sorted incoming files column list.

### DETAILED DESCRIPTION OF PREFERRED EMBODIMENTS

Preferred embodiments will now be described with reference to the drawings. For clarity of description, any element numeral in one figure will represent the same element if used in any other figure.

The present invention provides an encryption analysis and classification system (EACS) for analyzing and classifying files received by the EACS. The present invention provides the use of the complexity data analysis (CDA) method and system presented within PCT Application PCT/IL01/01074, related patent application to the present invention, which is incorporated herein by reference. Thus, the present invention provides accurate analysis and classification defining each file its type and whether it is encrypted and, given the fact it is encrypted, the encryption level using the CDA. The use of the CDA for analyzing and classification for files and their level of encryption is possible by exploiting a characteristic attribute included within all files transferred over communication lines. The complexity characteristic attribute determinates that all file types have a different level of complexity. The characteristic attribute is detectable by the EASC. Furthermore, encrypted files differ from unencrypted files by having a substantially more complex structure that is detectable by the EACS.

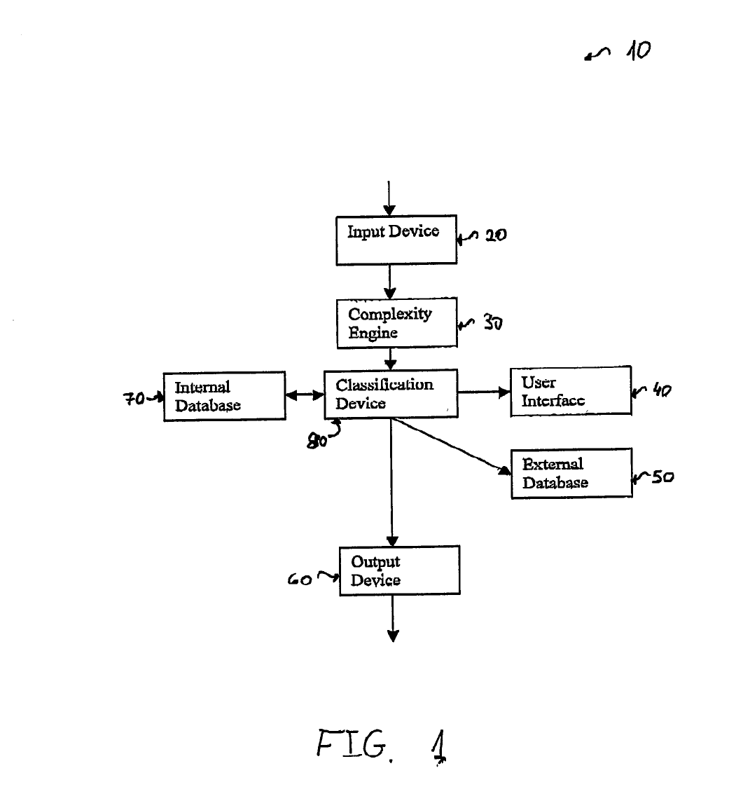

The complexity value calculated by the EACS is used for classifying of files within the EACS. The files received as input of the EACS are analyzed and classified and are provided as output of the EACS. The complexity value given to each file is calculated using the complexity engine within the EACS (according to PCT Application PCT/IL01/01074). The complexity engine within the EACS provides each file with complexity values. The complexity value of files is given by using pre-inserted parameters to the EACS complexity engine database. According to one embodiment the said parameters can provide complexity value for a text file by treating each byte as a letter and calculating the complexity over a file using a mean complexity, other complexity statistics, etc. Classification of files is performed by the EACS by comparing internal database thresh-hold parameters to received complexity values of files. Thus, a received complexity value is classified according to the range of thresh-holds values within the EACS. According to one embodiment an encrypted text file will be distinguished from the same unencrypted text file by the complexity value given by the EACS complexity engine. Consequently, the EACS is applied according to the present invention to sort between incoming files over the Internet or other communication lines. One skilled in the art can appreciate that in a similar manner the EACS can analyze and classify image files, text files and the like. The EACS will be better understood relating to FIG. 1.

FIG. 1 depicts a block diagram illustrating the process executed by the EACS 10. The EACS 10 consists from an input device 20, user interface 40, external database 50, output device 60, internal database 70, complexity engine 30 and a classification device 80. The input device 20 is a device for capturing files. One example of an input device 20 can include a computing device including a browser connected to a communication device that can be connected to a data communication network such as the Internet and other communication lines that provide the transfer of files in a digital manner. The input device 20 transfers the file to the computing device as a complexity engine 30 that calculates the complexity of received files. The complexity engine 30 is illustrated and explained within PCT Application PCT/IL01/01074 incorporated to the present invention. The classification devise 80 is a computing device that compares the complexity parameters values of the files to those within the internal database 70. The classification device 80 includes a classification handler (not shown) and is connected to the internal database 70 containing the parameters to be compared with the complexity value given to a file by the complexity engine 30. After the classification device 80 performs the said comparison the said file receives a classification number. The classification number given by the classification device 80 is used for storing the said file at the external database 50. The classification number given to the said file by the classification device 80 is used also for storing the said file within the internal database 70. The incoming files and their classification numbers can be presented at the user interface 40 for display. The user interface 40 can be a screen display unit or any other display unit. The user interface 40 can include an input device (not shown) for adding and modifying parameters and data required for the complexity engine's 30 internal database (not shown) and for the modification of the internal database 70 of the classification device 80.

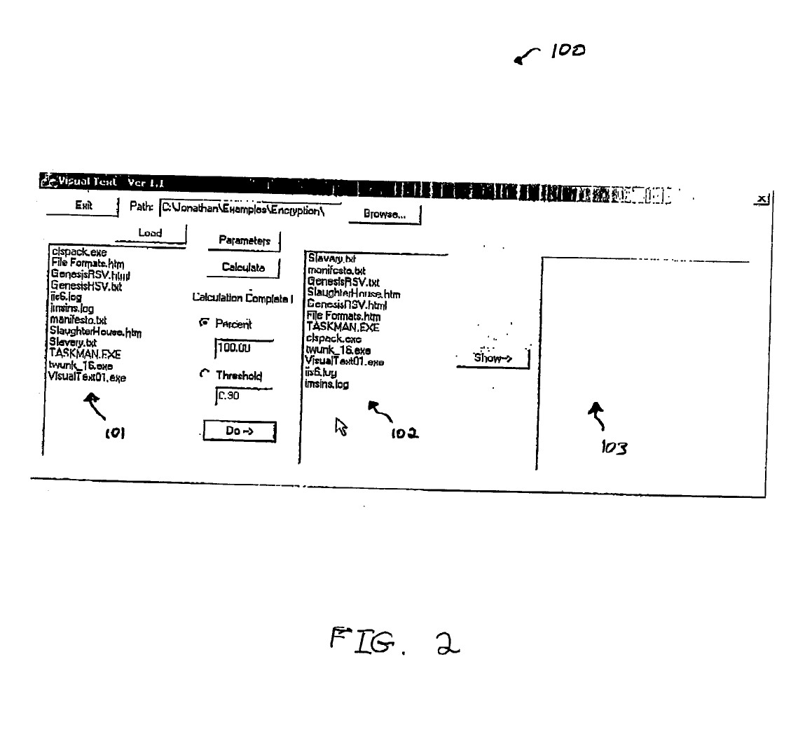

One preferred embodiment is depicted within FIG. 2. FIG. 2 depicts a screen shot 100 presenting the unsorted incoming file column list 101 and the sorted incoming files column list 102. The sorting of the incoming files within the present embodiment is performed by the EACS. Accordingly, the files received at the input device 20 as illustrated in FIG. 1 have their complexity value calculated within the complexity engine 30. The complexity values received from the complexity engine 30 are classified within the classification device 80 and are compared to thresh holds received from the internal database 70 based on previous files or parts there of received within the EACS or predetermined data inserted by the user. The classification device 80 stores the received files with their calculated complexity values within the external database 50. The classification results received from the classification device 80 presents to the user interface 40 the classification of all files according to their complexity calculation. FIG. 2 depicts the results presented to the user at the screen display of the user interface. The incoming files column list 101 is separated from the sorted incoming files column list 102. The sorted file column list 102 is sorted according to the complexity values given within the EACS. The present preferred embodiment provides the possibility to display the most “interesting” files on the highlighted files column list 103. The highlighted files column list 103 can present on the screen display of the user interface the files that have the highest complexity value.

The person skilled in the art will appreciate that what has been shown is not limited to the description above. Those skilled in the art to which this invention pertains will appreciate many modifications and other embodiments of the invention. It will be apparent that the present invention is not limited to the specific embodiments disclosed and those modifications and other embodiments are intended to be included within the scope of the invention. Although specific terms are employed herein, they are used in a generic and descriptive sense only and not for purposes of limitation.

What is claimed is:

1. A method for analysis and classification of electronic data, the method comprising:
receiving a file from an input device;
calculating complexity of the file received;
classifying the complexities of file;
displaying the file on a user interface; and
storing the file and their given classifications.

2. A system for analysis and classification of files, the system comprising:
an input device for capturing files;
a computing device for calculating complexities of the captured files;
a computing device for classification of complexities of files interacting with a storage device, a user interface and the input device;
wherein the storage device provides the computing device, the user interface and input device with relevant information of the captured, analyzed and classified files;
wherein the user interface device displays files and their classifications to a user.
